(19) United States
(12) Patent Application Publication
(10) Pub. No.: US 2010/0082574 A1
(43) Pub. Date: Apr. 1, 2010

(54) Method for song credit search and discovery

(76) Inventors: Ryan Nile Sutherland, London (GB); Jemma Nadine Arjun, London (GB); Ralph Wayne Maser, Stiwell, KS (US); Rod Underhill, Julian, CA (US)

Correspondence Address: WHITE-WELKER & WELKER, LLC, P.O. BOX 199, CLEAR SPRING, MD, 21722-0199, US

(21) Appl. No.: 12/236,681

(22) Filed: Sep. 24, 2008

(51) Int. Cl. G06F 7/06; G06F 17/30

(52) U.S. Cl. 707/706; 707/E17.014

(57) ABSTRACT

The present invention relates to a computer method and system for maintaining and delivering data, text, and graphics relating to musical and voice recordings over the Internet to end users operating personal computers and portable electronic devices in an inter-connected manner. The Database of Music related information (Song for Song) improves on what currently exists by providing factual information, not only by Album, but for each individual song.

### FEDERALLY SPONSORED RESEARCH

Not Applicable

### SEQUENCE LISTING OR PROGRAM

Not Applicable

### CROSS REFERENCE TO RELATED APPLICATIONS

This application claims priority from U.S. Provisional Patent Application Ser. No. 60/974,772, entitled “Database of Music related information (Song for Song)”, filed on 24 Sep. 2007. The benefit under 35 USC §119(e) of the U.S. provisional application is hereby claimed, and the aforementioned application is hereby incorporated herein by reference.

### TECHNICAL FIELD OF THE INVENTION

The present invention relates generally to a method for searching a database for musical information. More specifically, the present invention relates to a method for searching a database for song credits and other related information.

### BACKGROUND OF THE INVENTION

A fan of a musical group could use the present invention to learn information heretofore unknown to the fan. Upon reviewing the material provided by the Invention, the fan learns that one particular Beach Boy song featured the bass guitar as played by session artist Carol Kaye. By clicking on the name “Carol Kaye” the fan would learn that Carol Kaye also provided session work on a wide variety of other sound recordings The importance and validity of the present invention is heightened by the expectation that hard copy sales of CDs may be discontinued by the labels in the near future. The present invention allows a user to create custom albums with custom art, by way of “adding” songs to a “basket” through the interconnectedness of the invention using the above example, the invention allows consumers to create a Carol Kaye custom album compilation. The present invention allows users to highlight and “dissect” what effects/tools musicians have used to create certain sounds in a song.

### SUMMARY OF THE INVENTION

The present invention relates to a computer method and system for maintaining and delivering data, text, and graphics relating to musical and voice recordings over the Internet to end users operating personal computers and portable electronic devices in an inter-connected manner. The Database of Music related information (Song for Song) improves on what currently exists by providing factual information, not only by Album but for each song.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1. shows a typical multi-user network known in the prior art;

FIG. 2 shows a simplified high-level logic diagram of a system constructed in accordance with the present invention;

FIG. 3 shows diagram of one embodiment of a system constructed in accordance with the present invention;

FIG. 4 shows an embodiment of a web page display consisting of album level information stored in the database according to the present invention; and

FIG. 5 shows an embodiment of a web page display consisting of song level information stored in the database according to the present invention.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, the system-known structures and techniques known to one of ordinary skill in the art have not been shown in detail in order not to obscure the invention.

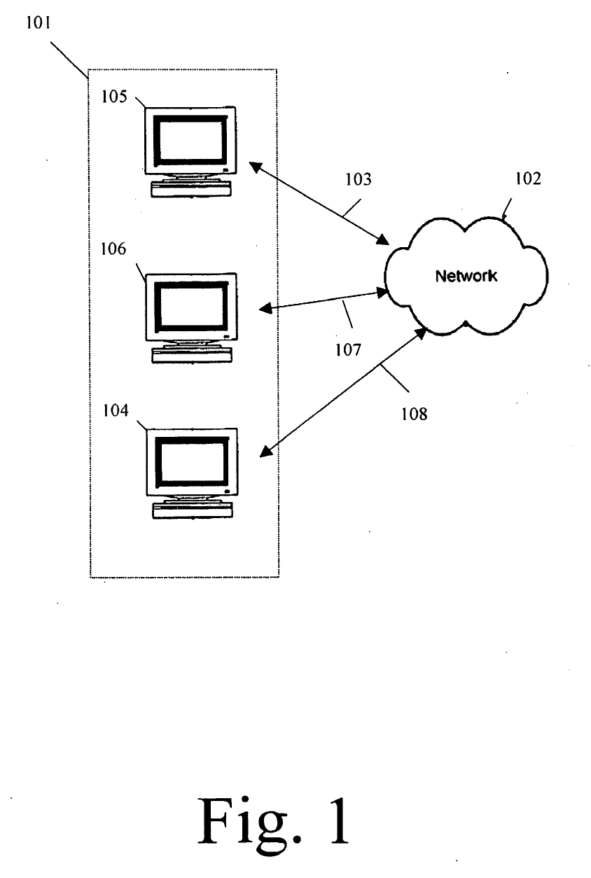

Now referring to FIG. 1, as known in the prior art, the Internet 100 comprises a vast number of computers 101 and computer networks 102 that are interconnected through communication links 103, 107, and 108. The interconnected computers 101 exchange information using various services, such as electronic mail, Gopher, and the World Wide Web (“WWW”) or Internet. The Internet service 100 allows a server computer system 104 (i.e., Web server or Web site) to send graphical Web pages of information to a remote client computer systems 105. The remote client computer systems 105 and 106 that can then display the Web pages. The Internet service 100 can also facilitate the distribution of electronic files that are designed for use by portable devices such as cell phones and portable MP3 music players, which may use MP3 formatted files or other compressed music and video files of various and sundry nature.

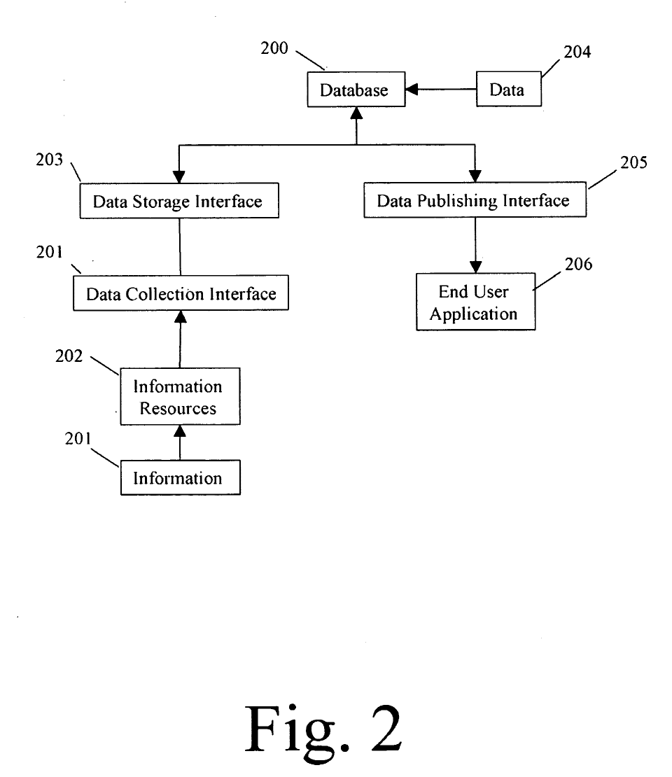

Now referring to FIG. 2, the present invention relates to a database 200 of music related information comprising the following components: a means for collecting information 201 which extracts information from Album Booklets and other information provided/collected 202; a means for entering data 203 that provides detailed information to be stored into a database 200, the data 204 that has been inputted into the database 200 is sorted and stored in and by the database 200 in a way where everything relevant is linked to each other on the fly, and can be searched through each other; and a means for publishing 205 that provides published data on a end user application 206 such as a web page or other portable electronic device with a display, allowing for an inter-connected environment throughout the database 200. In alternative embodiments, an end user application can be more than just a Web Page displayed on a computer or other portable electronic devices. The present invention can be used on any sattelite/internet receiving device such as TV's and Radio as well. So just to make that clearer. Some data 204 may only be accessed by subscription. Some content (i.e. Music Downloads, Custom Art, Contact details for people in the database 200, copyright/publishing right holder information) may only be accessed by subscription.

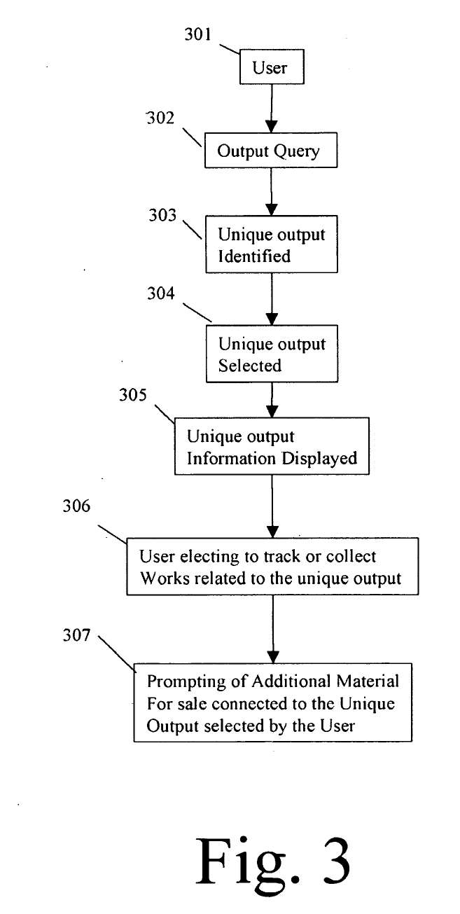

Now referring to FIG. 3, an example is as follows: A user 301 who is a fan of the Beach Boys musical group could use the present invention to learn information heretofore unknown to the fan. Upon reviewing the material provided by an output query of the present invention 302, the fan learns that one particular Beach Boy song featured the bass guitar as played by session artist Carol Kaye, identified as a unique output 303. By clicking or selecting the name “Carol Kaye” 304 identified as a unique output 303 the user 301 would learn more information 305 about Carol Kaye. For example, the fan may learn that Carol Kaye also provided session work on a wide variety of other sound recordings: The Beach Boys: “Wouldn't It Be Nice,” “Help Me Rhonda,” “Good Vibrations,” “Caroline No,” “Sloop John B,” “Heroes and Villains,” “California Girls,” and most of Pet Sounds LP. Electric guitar on an earlier hit, “Surfin' USA.” Plus work for Joe Cocker (“Feelin' Alright”) Barbra Streisand (“The Way We Were”), the Marketts (“Batman Theme”), Simon & Garfunkel (“Homeward Bound”), the Righteous Brothers (“Soul & Inspiration”), Ike and Tina Turner (“River Deep Mountain High”), Ray Charles (“America The Beautiful” & “Don't Change On Me” & “I Don't Need No Doctor” & “I Chose To Sing The Blues” & “Understanding” & “Feel So Bad”) Brenda Holloway (“You Made Me So Very Happy”), Herb Alpert and the Tijuana Brass (“Whipped Cream”), Andy Williams (“Love Story”) Lou Rawls—“Natural Man,” “Unforgettable” & “Tobacco Road” Glen Campbell—“Wichita Lineman” and others Motherlode—“When I Die” Frank and Nancy Sinatra—“Something Stupid” Nancy Sinatra—“These Boots Are Made For Walkin',” “Sugar Town” Additional songs by the Monkees, Gary Lewis & the Playboys, the Buckinghams, Paul Revere & the Raiders, Gary Usher, Gary Puckett and Union Gap, Bill Cosby—“Hikky Burr” & “Chump Change” with Quincy Jones, Guitar hits: (“La Bamba”) Ritchie Valens; (“Zippity Doo Dah”) Bob B. Soxx & Blue Jeans; (“Unchained Melody” & “You've Lost That Lovin' Feelin'”) Righteous Bros.; (“The Beat Goes On,” “He's A Rebel,” “I Got You Babe,” “Baby Don't Go,” “All I Really want To Do” & “Bang Bang”) Sonny & Cher; (“Danke Shoen”) Wayne Newton; (“Mexican Shuffle”) Herb Alpert and the Tijuana Brass; (“Mothers Of Invention & Freak Out” LPs) Frank Zappa.

Via the method of the present invention with this example, the user could then be converted to a collector of Carol Kaye 306. This example shows that a single search on any music professional could open up a new realm of possible music purchases for the user that until now may have been completely unknown. The invention model of searching from song credits encourages music purchases/subscriptions.

Additionally, the present invention allows for the prompting of additional sales 307 as identified by the provision of additional recording data, graphics and text previously unknown to the potential purchaser. The invention increases the likelihood of the sales of digital downloads and hard copy recordings by the provision of information not readily available to any person who does not already own a copy of the original album (LP, or that is, vinyl album and/or “45”) or CD copy of the recording. Purchases of digital downloads may access otherwise unavailable graphics, text and data and such data is interrelated so that a person interested in learning more about a particular recording studio, performer, label, artist, sideman, engineer, cover artist/photographer and other professionals involved with a particular recorded song or collection of songs will be provided information regarding other recordings that a particular professional was involved with, thus enhancing sales via the production of this information.

The importance and validity of the present invention is heightened by the expectation that hard copy sales of CDs may be discontinued by the labels in the near future. The present invention allows a user to create custom albums with custom art, by way of “adding” songs to a “basket” through the interconnectedness of the invention. Using the above example, the invention allows consumers to create a Carol Kaye custom album compilation. The present invention allows users to highlight and “dissect” what effects/tools musicians have used to create certain sounds in a song.

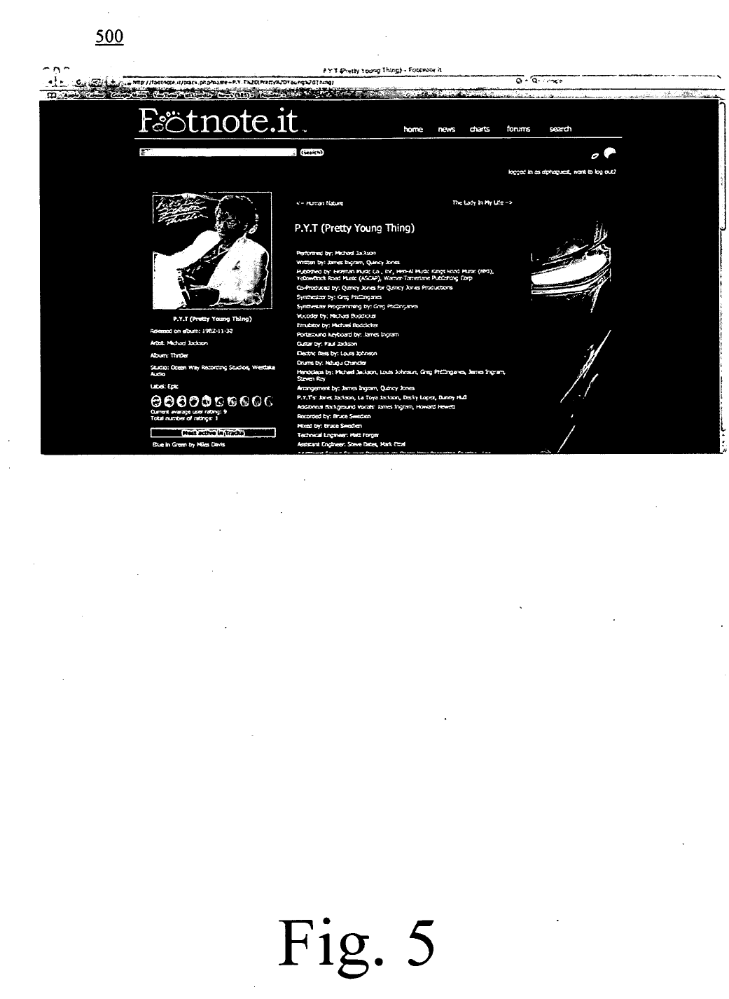

Now referring to FIG. 6, the present invention aggregates the published and unpublished data, text and graphics relating to all recordings issued by a recording label and interconnects them so that all “liner notes,” photographs, session information, and professionals contributing and/or credited to all albums and single recordings released by a label can be accessed in a hyper-linked environment. The invention is specific to, but does not limit to, publishing on a web-page 500 as illustrated in FIG. 5.

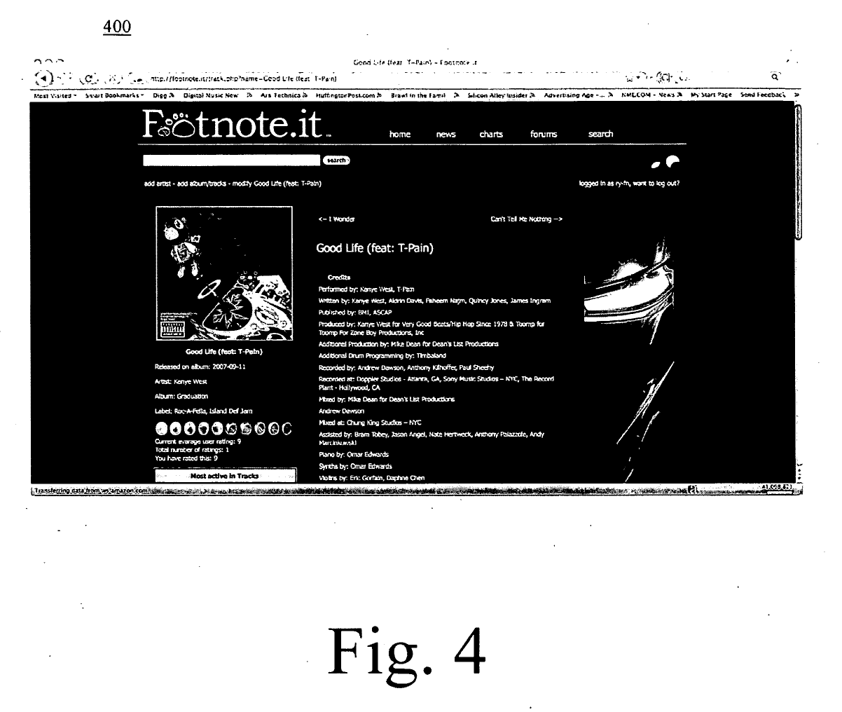

Now referring to FIGS. 4-5, the present invention aggregates information found in Album booklets and other resources 400 as illustrated in FIG. 4, graphics and text for educational, artistic and preservation purposes designed to enhance the sale of musical recordings and packages it for distribution to personal computers and portable electronic devices. Data and additional material 500 collected and used by the Invention comprises song title, album title, record label imprint, recording artist, publisher, date of recording, date of release, charting history, recording studio, producer, engineer, guest performers, hired performers (sidemen), liner notes, album artwork and photography, interior artwork and photography, unused and previously unpublished session photography and other information, data, text and graphics as illustrated in FIG. 5.

In an alternative embodiment, the present invention provides third parties with the ability to display the published date on or in combination with the third parties own published date. In a web page embodiment this would be enabled by allowing a third party to access the API (application programming interface) of the present invention's servers to load portions of information for the present inventions data from the database onto the third party products.

Some information may be accessible only by subscription, if needed. Information extracted from booklets may be used to launch supporting features of the invention such as discovering songs via “trackback” our feature that allows you to find any song that has been played at any time, on any media medium for example radio stations, where you can “trackback” all songs that have been played at any time, with interconnected links providing published information earlier extracted and direct purchasing links; for example, publishing companies can monitor how much times a song has come on, where, when and on what. Information extracted from booklets may be used to launch supporting features of the invention such as concert/pre recorded and live performance streaming via the invention publishing apparatus (website).

Furthermore, other areas of art may benefit from this method and adjustments to the design are anticipated. Thus, the scope of the invention should be determined by the appended claims and their legal equivalents, rather than by the examples given.

I claim:

1. A computer implemented method for song credit search and discovery comprising the steps of:
a) collecting data;
b) entering data that provides detailed information to be stored into a database;
c) publishing date that provides published data on an end user application;
d) aggregating the published and unpublished data, text and graphics relating to all recordings issued by a recording label;
e) interconnecting said published and unpublished data;
f) allowing for an inter-connected environment throughout the database;
g) searching from song credits;
h) returning a search query; and
i) packaging the search query results for distribution.

2. The method of claim 1, wherein the data may only be accessed by subscription.

3. The method of claim 1, further comprising the step of:
j) creating custom albums with custom art, by way of adding songs to a basket through the interconnectedness of the invention.

4. The method of claim 1, further comprising the step of:
k) discovering songs by finding any song that has been played at any time, on any media medium; and
l) providing interconnected links consisting of published information earlier extracted and stored in the database; and
m) providing direct purchasing links.

5. The method of claim 1, wherein information extracted from booklets may be used to launch pre recorded and live performance streaming via the publishing means.

6. The method of claim 1, wherein the data that has been inputted into the database is sorted and stored in and by the database in a way where everything relevant is linked to each other and can be searched through each other.

7. The method of claim 1, wherein the text and graphics relating to all recordings issued by a recording label so that all liner notes, photographs, session information, and professionals contributing and/or credited to all albums and single recordings released by a label can be accessed in a hyper-linked environment.

8. The method of claim 1, further comprising the step of:
n) packaging the search query results for distribution to personal computers and portable electronic device

9. The method of claim 1, further comprising the step of:
o) creating custom albums with custom art.

10. The method of claim 1, further comprising the step of:
p) aggregating information found in information resources which contain graphics and text for educational, artistic, and preservation purposes designed to enhance the sale of musical recordings; and
q) packaging the aggregated information for distribution to personal computers and portable electronic devices.

11. The method of claim 10, wherein the data collected includes information from Album Booklets.

12. The method of claim 1, wherein the data collected is comprised of information found in a: song title, album title, record label imprint, recording artist, publisher, date of recording, date of release, charting history, recording studio, producer, engineer, guest performers, hired performers (sidemen), liner notes, album artwork and photography, interior artwork and photography, unused and previously unpublished session photography.

13. A computer system that performs song credit search and discovery, the system comprising:
a plurality of computers;
a plurality of multi-user computer networks;
communication links providing connection between the multi-user computer networks;
a server computer system for sending graphical information to remote client computer systems;
a remote client computer system can then display the graphical information;
said communication links providing a distribution of electronic files;
said server computer system further comprising:
an input interface adapted to receive data that provides detailed information to be stored into a database;
an output interface adapted to publish data on an end user application;
a database for aggregating the published and unpublished data, text and graphics relating to all recordings issued by a recording label;
said database interconnecting said published and unpublished data,
an the input interface further adapted to search song credits, return a search query; and packaging the search query results for distribution.

14. The system of claim 13, wherein the data may only be accessed by subscription.

15. The system of claim 13, wherein the server computer system sends graphical web pages of information to a remote client computer system or portable electronic device.

16. The system of claim 13, wherein said communication links provide a distribution of electronic files that are designed for use by portable devices such as cell phones and portable music players.

17. The system of claim 13, wherein the returned search query includes;
finding any song that has been played at any time, on any media medium;
providing interconnected links in the graphical information consisting of published information earlier extracted and stored in the database; and
providing direct purchasing links in the graphical information.

18. The system of claim 13, wherein the output interface provides pre recorded and live performance streaming of video and audio files.

19. The system of claim 13, wherein the said database interconnecting provides that the data that has been inputted into the database is sorted and stored in and by the database in a way where everything relevant is linked to each other and can be searched through each other.

20. The system of claim 13, wherein
the server computer system sends graphical information directly to the end user device; and
the end user device consists of any electronic device capable of receiving a satellite signal.
